(19) United States
(12) Patent Application Publication
(10) Pub. No.: US 2006/0178059 A1
(43) Pub. Date: Aug. 10, 2006

(54) Propulsion system for and amphibious track driven vehicle

(76) Inventors: Kevin Winfred Metheny, West Lafayette, IN (US); Richard Paul McCormick, West Lafayette, IN (US)

Correspondence Address: PATENT ATTORNEY, P.O. BOX 4453, LAFAYETTE, IN, 47903, US

(21) Appl. No.: 11/291,261

(22) Filed: Dec. 1, 2005

Related U.S. Application Data
(60) Provisional application No. 60/632,202, filed on Dec. 1, 2004.

(51) Int. Cl. B60F 3/00

(52) U.S. Cl. 440/12.56

(57) ABSTRACT

A propulsion system for amphibious track driven vehicles. The propulsion system includes a driven track having for example paddles extending therefrom and supported by a suspension framework. The track is driven by drive cogs of for example plastic or metal. A manifold partially encloses the track and includes a water collection chamber positioned at the forward end of the track for collecting water from the top portion of the track. One or more exhaust tubes are coupled to the collection chamber and extend from the chamber toward the back end of the track. A propeller is positioned in each of the exhaust tubes to boost the thrust of the water through the tubes and out the back end of the track. Directional control is enhanced by varying the power to each of the propellers.

### CROSS-REFERENCE TO RELATED APPLICATIONS

This application claims priority of provisional application Ser. No. 60/1,632,202, filed Dec. 1, 2004.

### TECHNICAL FIELD

This invention is directed generally to a propulsion system and in particular to a propulsion system for an amphibious track driven vehicle.

### BACKGROUND OF THE INVENTION

Amphibious vehicles and boats or ships have been around for eons. They were built for many purposes such as sport, warfare, cargo and transportation of humans and animals alike in a myriad of different shapes and configurations. They have been constructed of stone, wood, reeds, plastic and metal with many different propulsion systems such as paddles, sticks, wind driven sails, manual, steam engine or fossil fuel powered and or electric motor driven paddles, wheels, propellers and screws. They have also been pulled by animals or humans for specific purposes as required by the situation.

### SUMMARY OF THE INVENTION

The present invention is directed to a propulsion system for amphibious track driven vehicles. This propulsion system is designed to create a new genre of amphibians from shallow draft water and land vehicle configurations to completely submerged vehicles that will allow the operator to traverse over or underwater and over ice, sand, snow, swamp and land with ease when desired. An advantage of this system is to allow access by the operator and their passengers or cargo into otherwise inaccessible areas. Uses for all kinds of activity from cargo transportation, search and rescue, military, sport and commercial fishing, scientific and adventure exploration will be greatly enhanced.

The propulsion system in an illustrative embodiment comprises a driven track made of, for example, composite metal, plastic and rubber supported by a suspension framework and driven by drive cogs of, for example, metal or plastic. Power to move the track is provided by on board engines or motors either directly or indirectly connected to mechanical driven systems, hydrostatic drive systems or combinations of both.

Depending on the size and type of the track driven amphibious vehicle or boat desired, this determines the size and number of propulsion systems used and how they are powered by primarily fossil fuel, gas, electric or hybrid systems. Track driven amphibious vehicles or boats can be of a variety of different configurations depending on their desired need as a single hull boat, catamaran or tri-maran or multi-hull boat of all shapes and sizes. Even submarines can be powered by this propulsion system using a passive jet drive or a powered jet drive system, which until now was completely unknown for paddle driven systems.

### BRIEF DESCRIPTION OF THE DRAWING

FIGS. 1 through 68 depict various views of an amphibious track driven vehicle and the water propulsion system for the vehicle of the present invention.

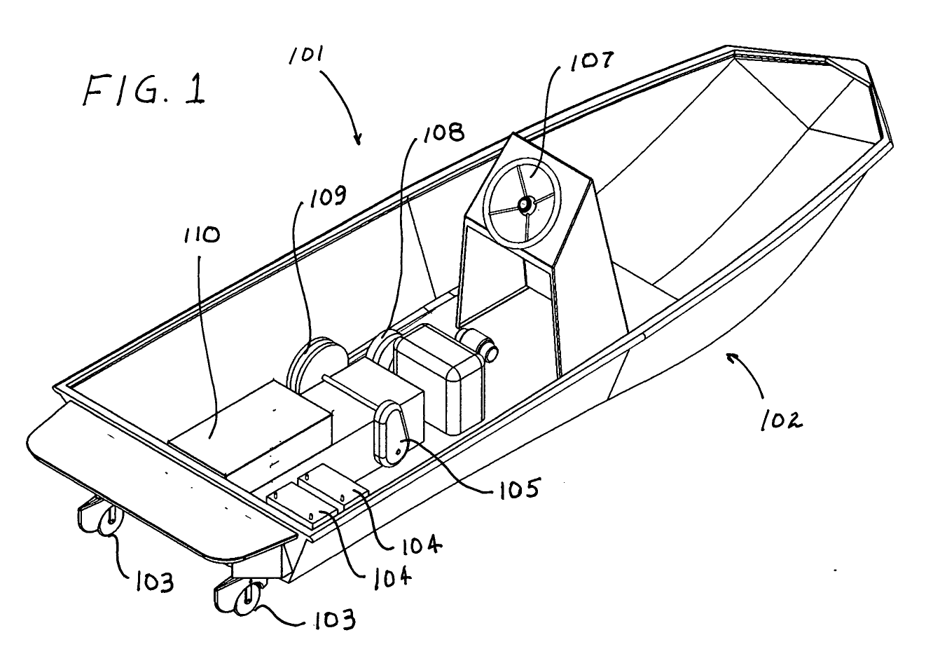

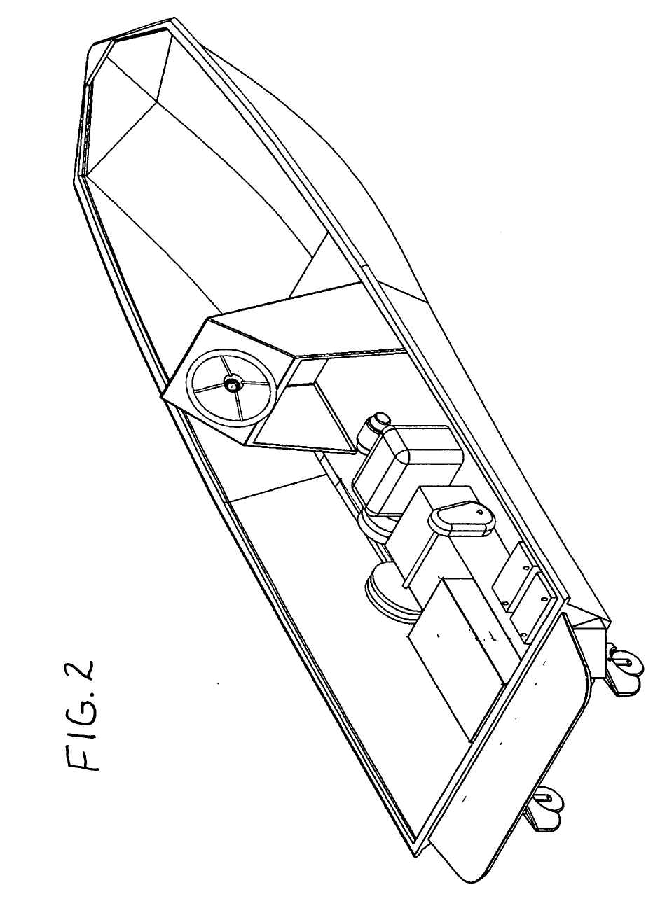

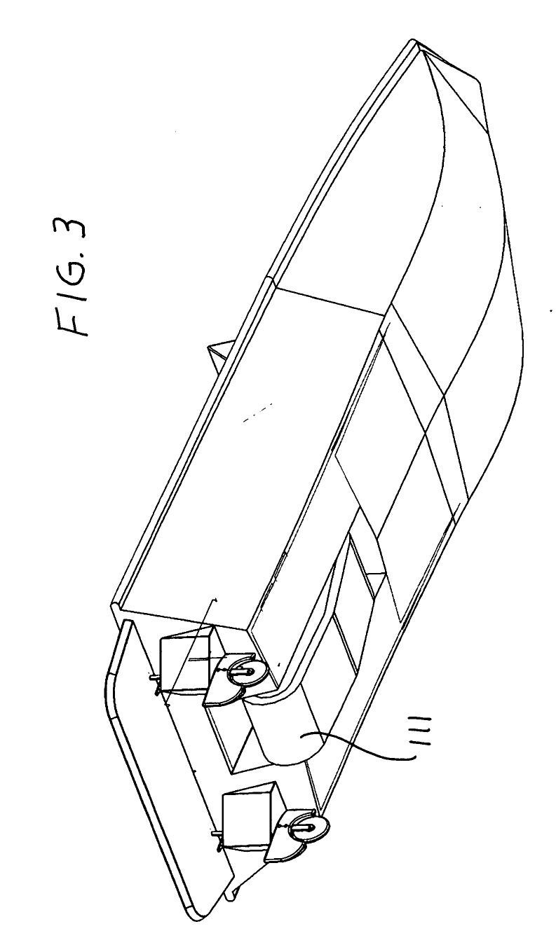

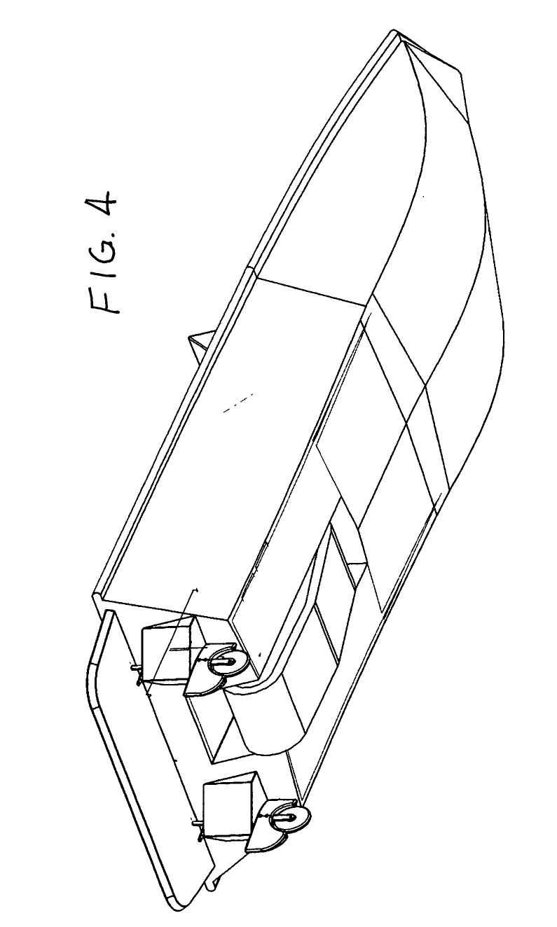

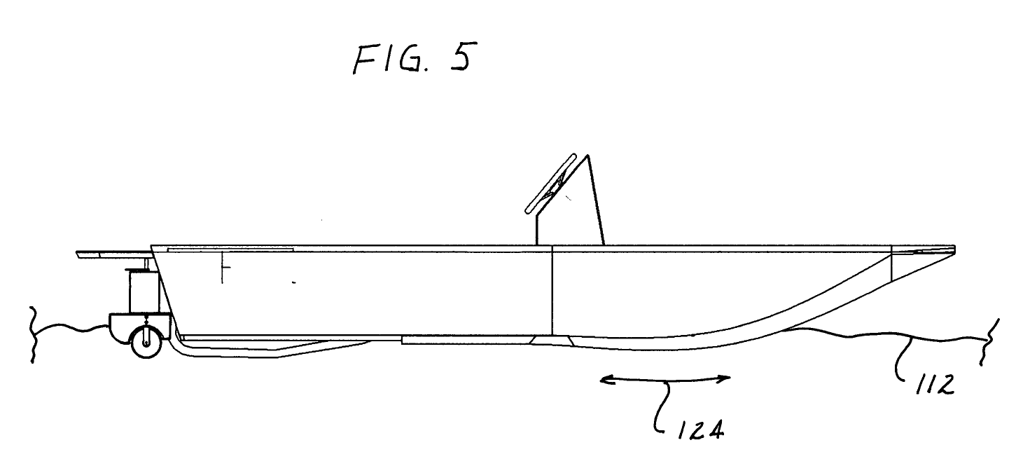

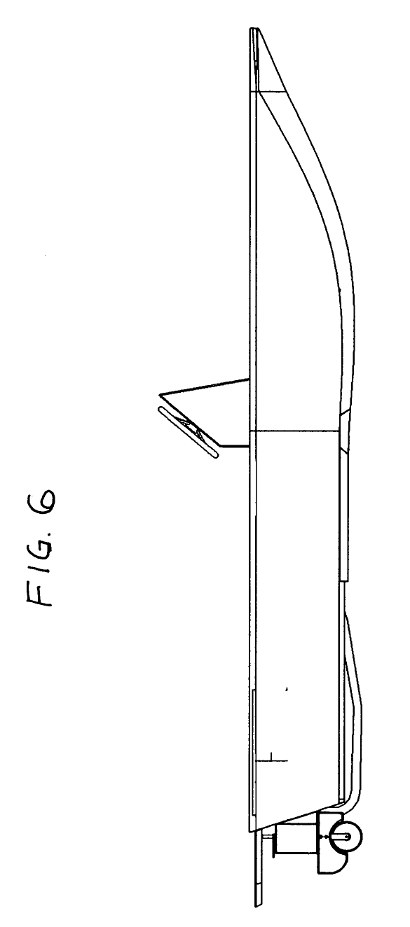

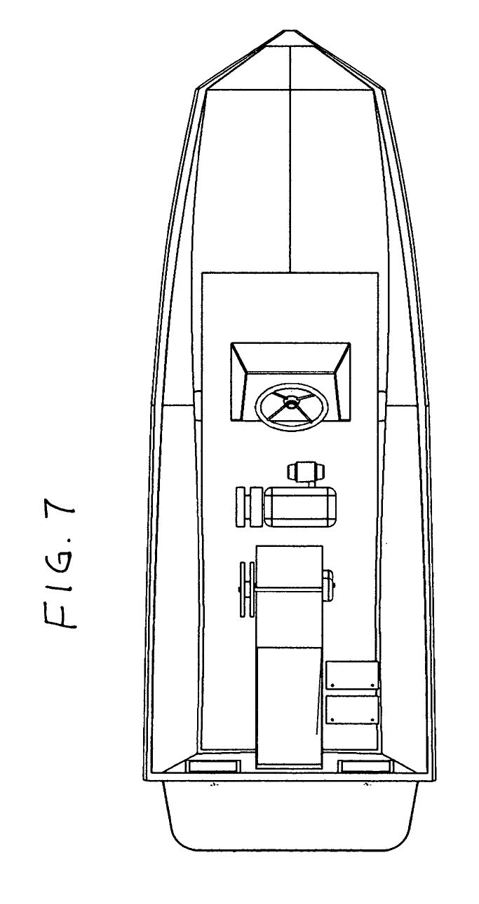

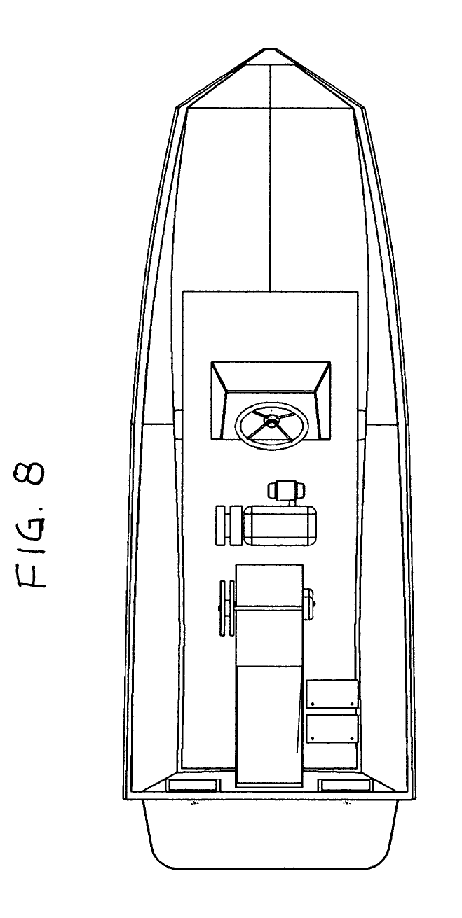

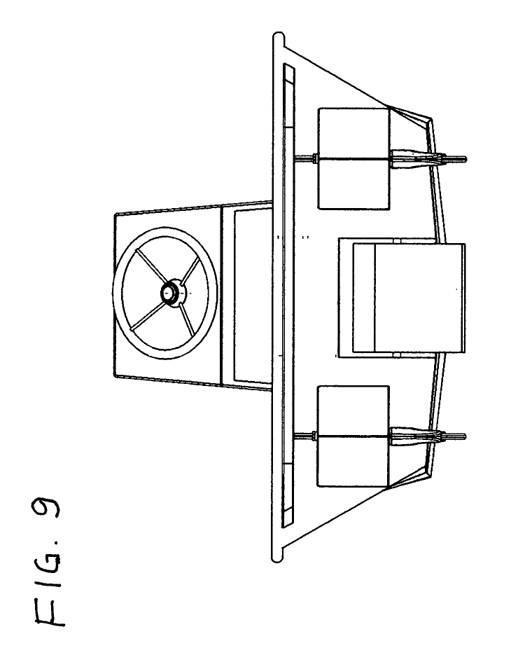

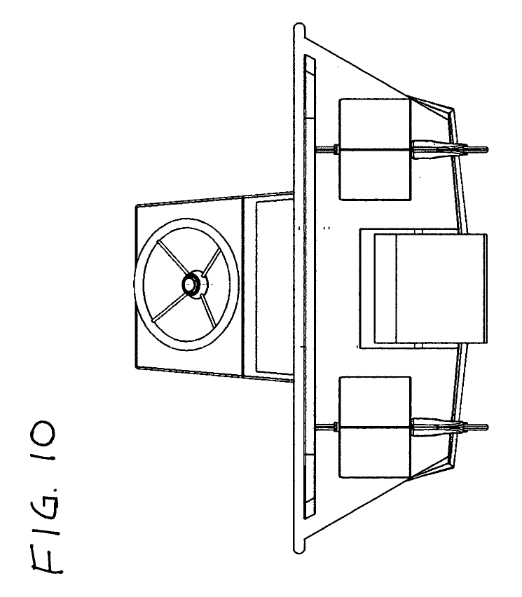

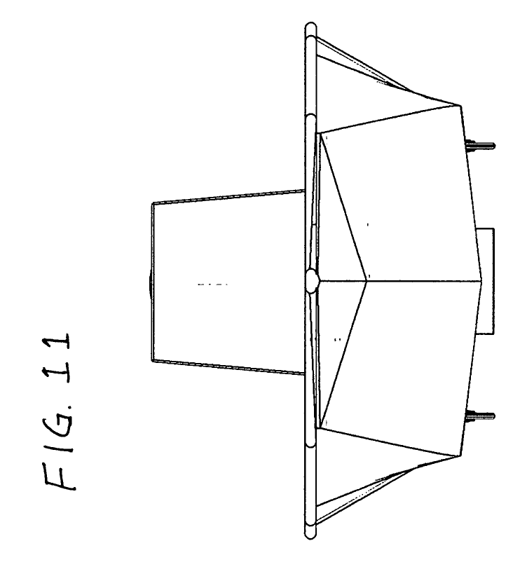

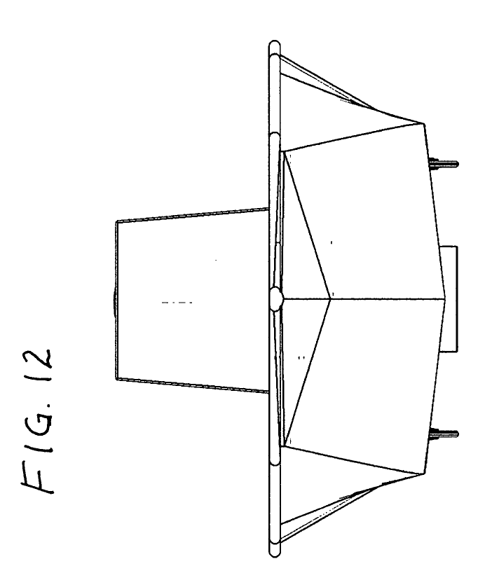

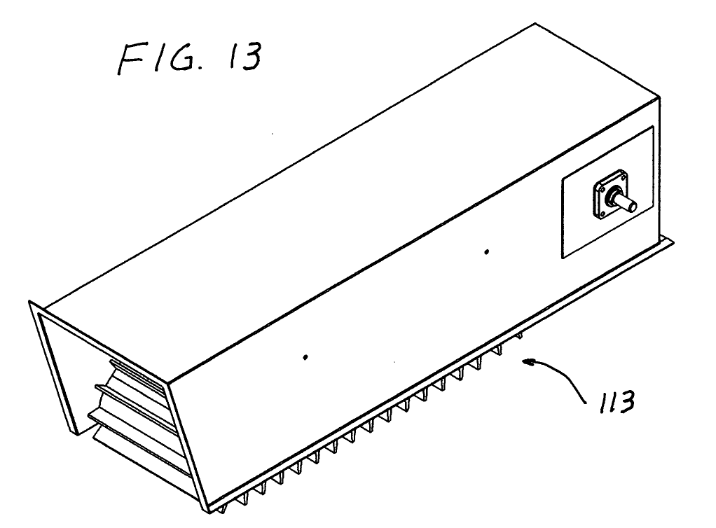

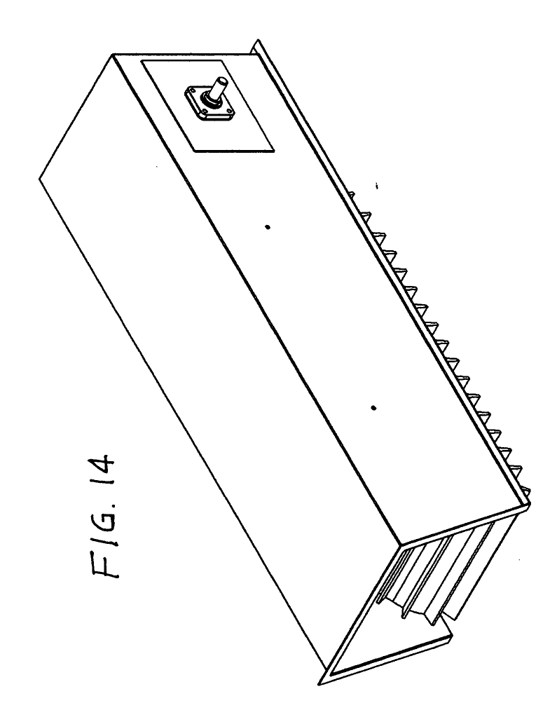

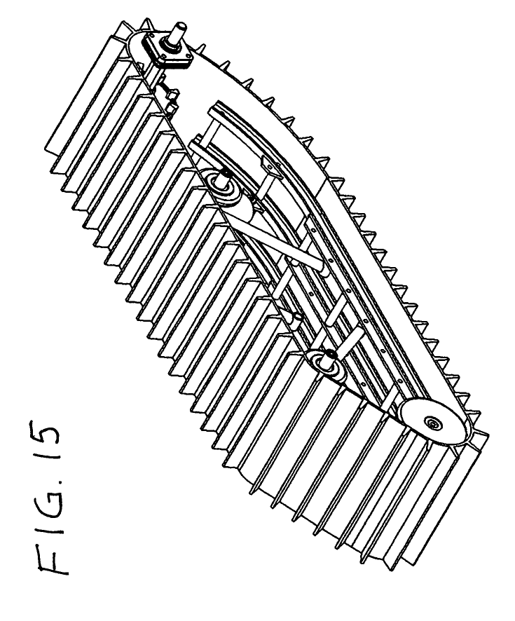

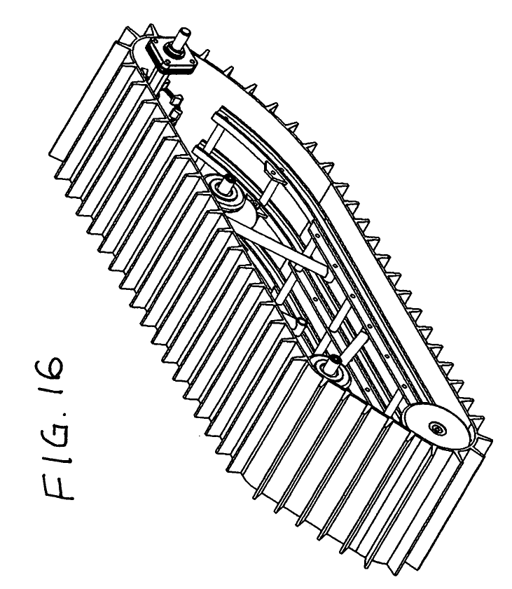

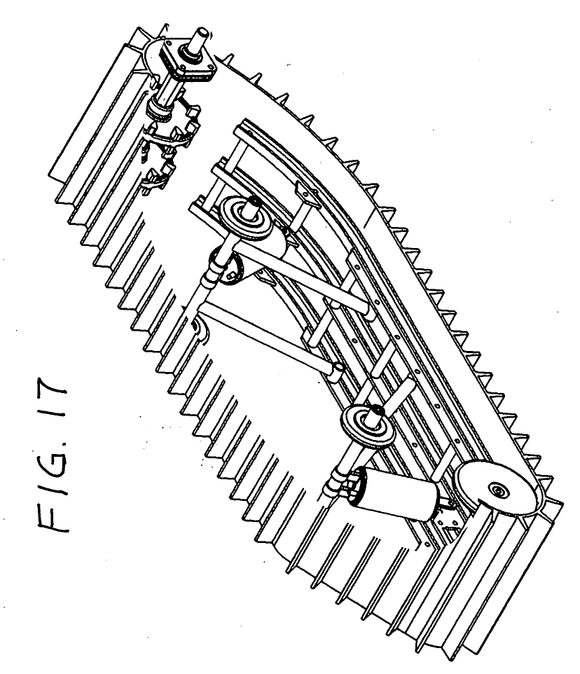

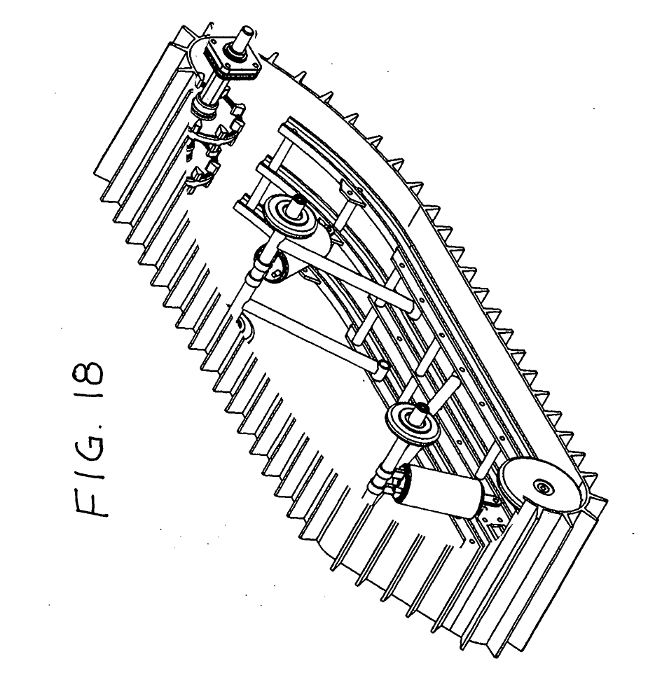

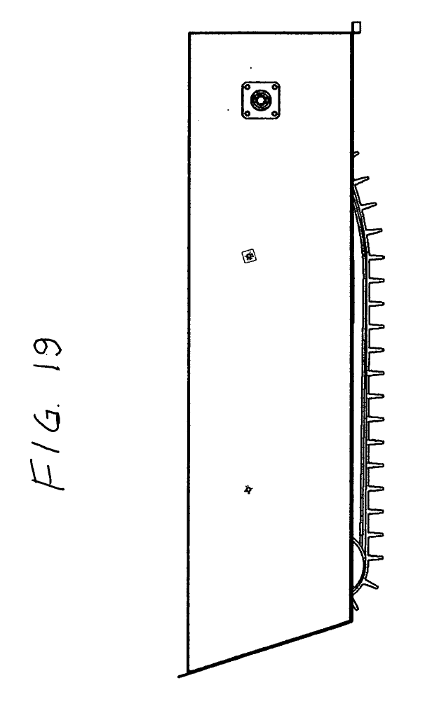

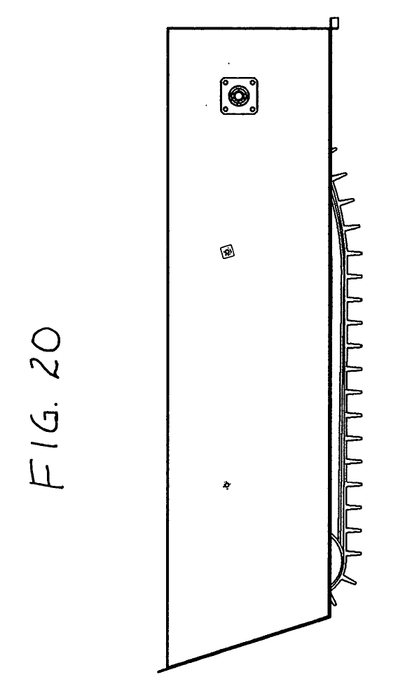

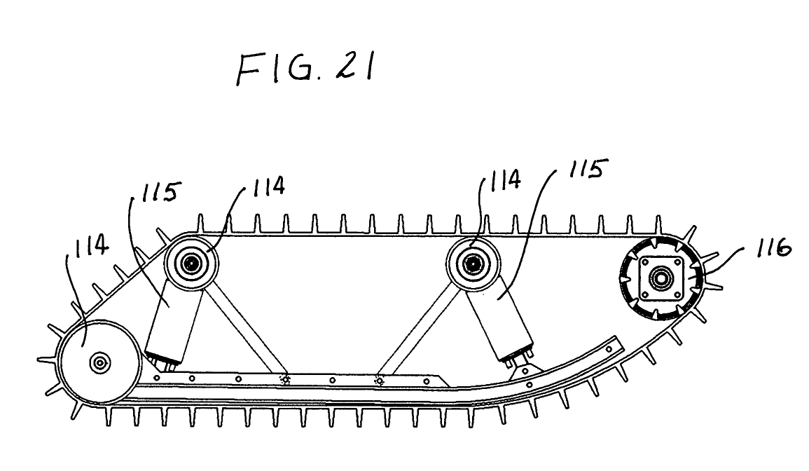

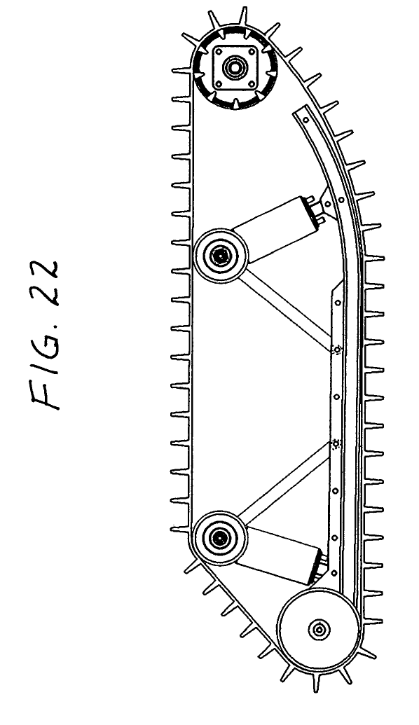

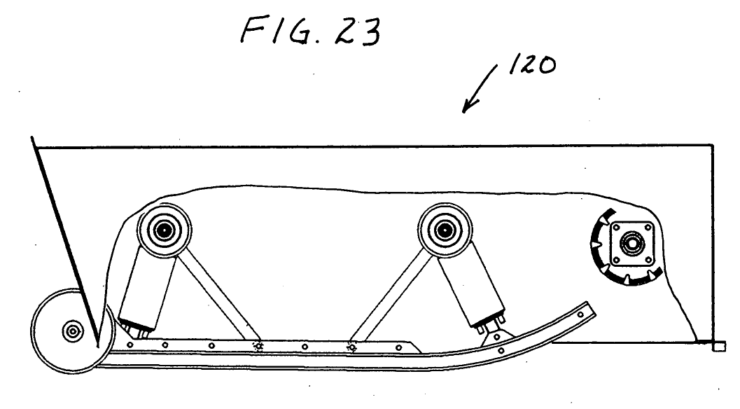

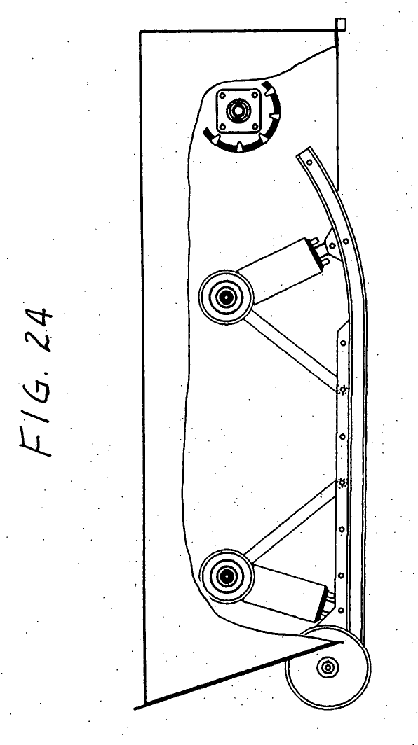

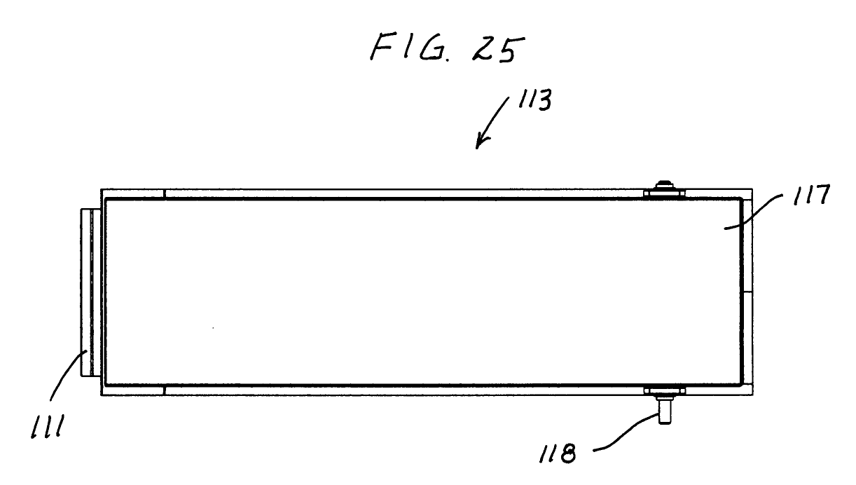

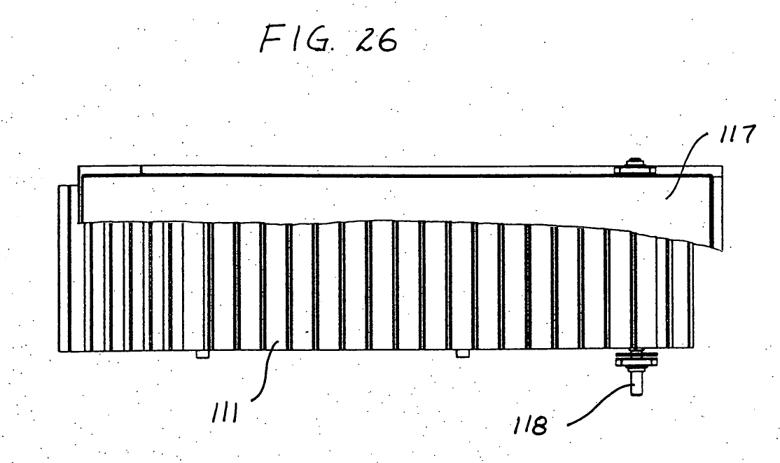

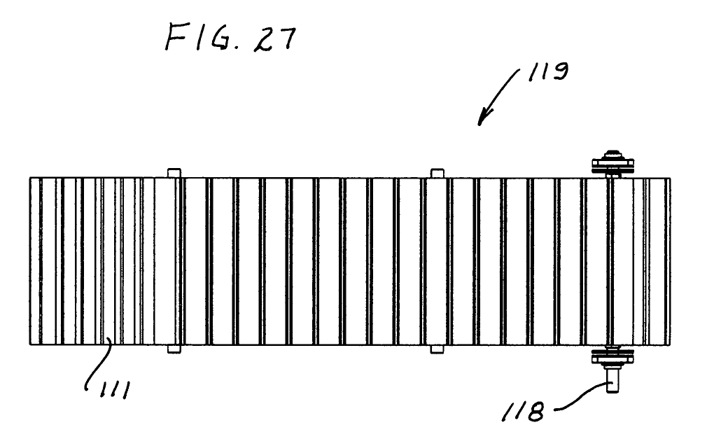

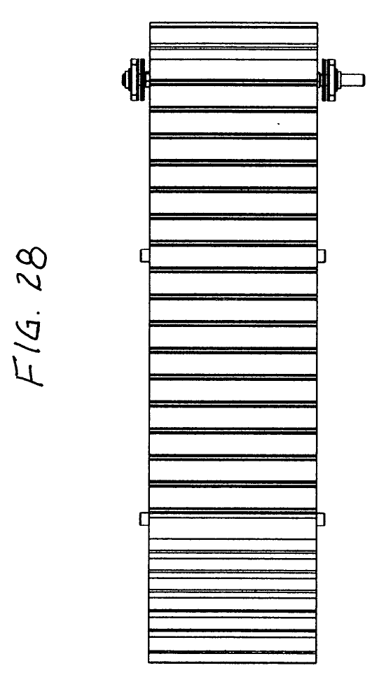

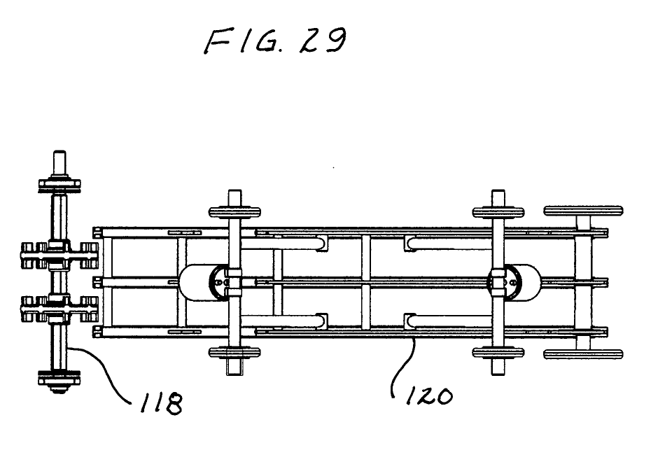

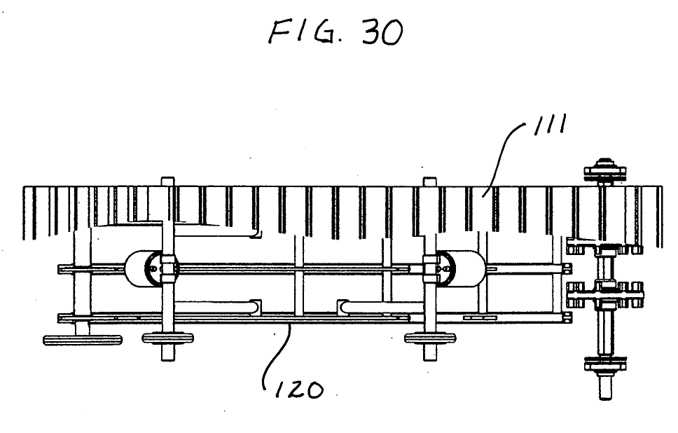

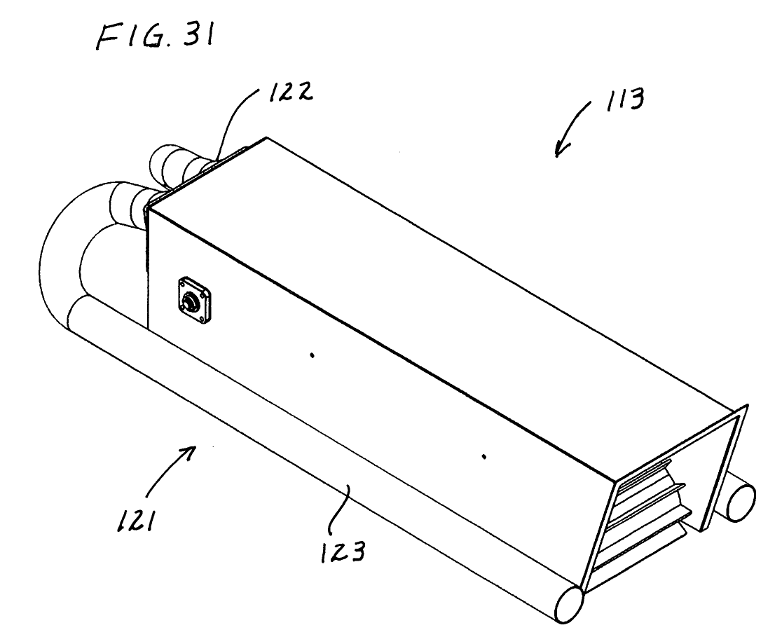

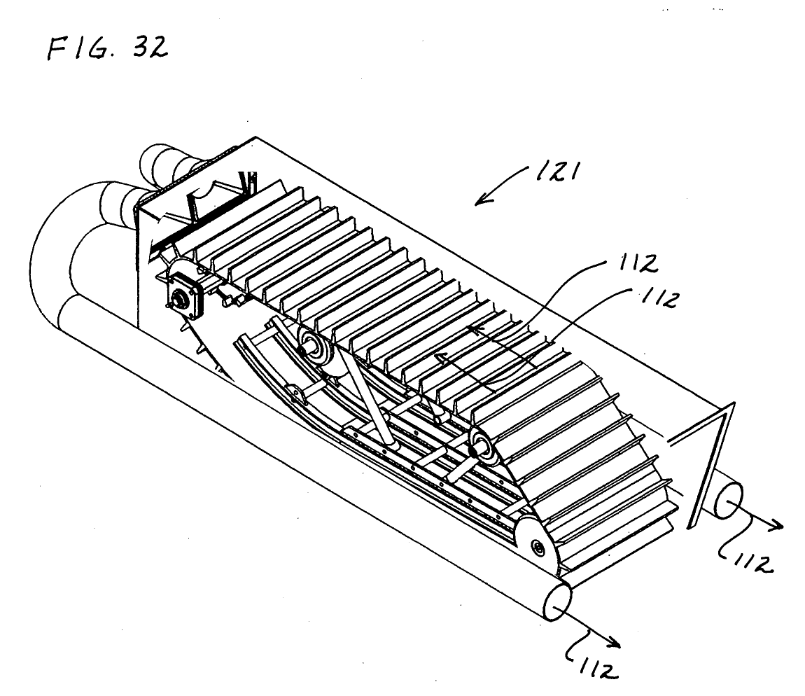

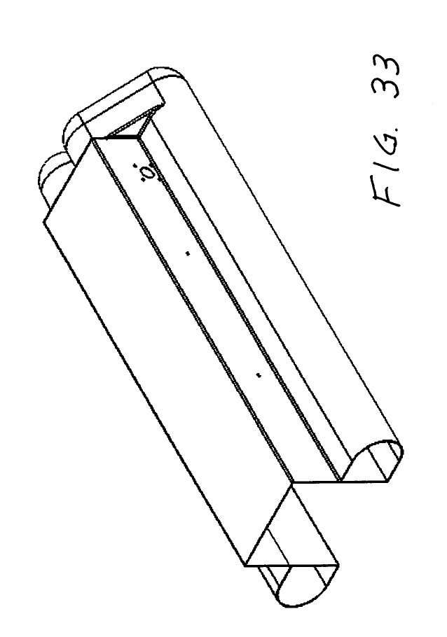

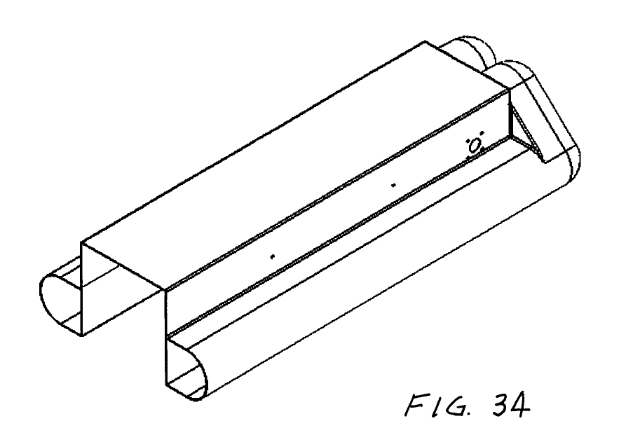

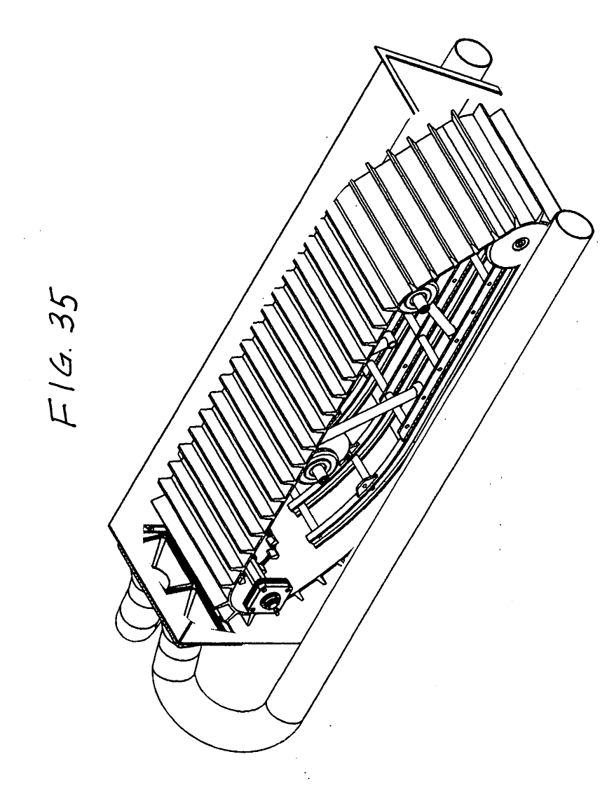

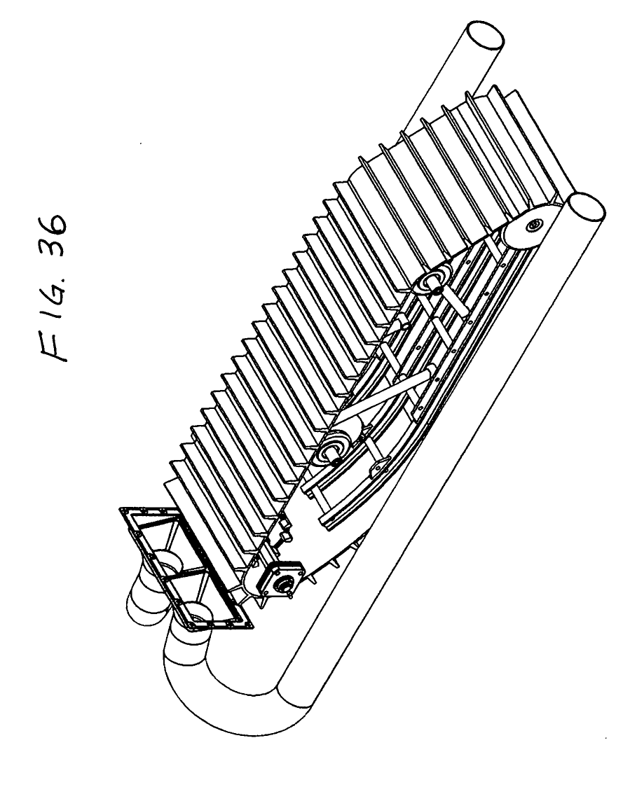

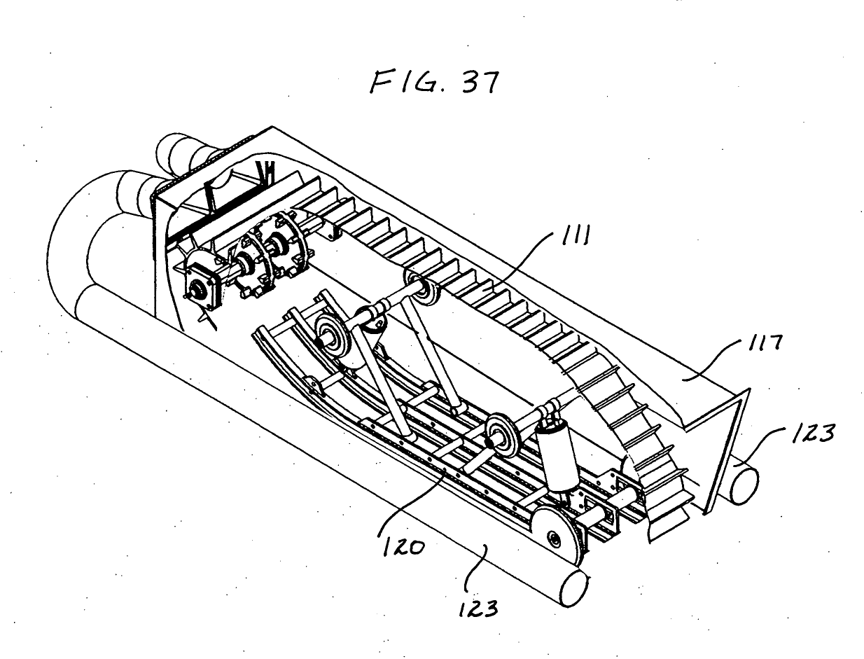

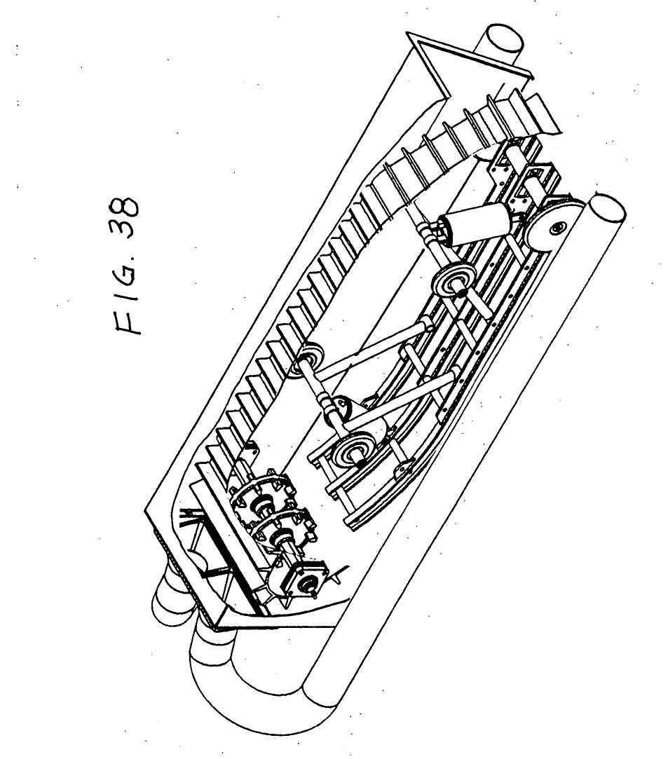

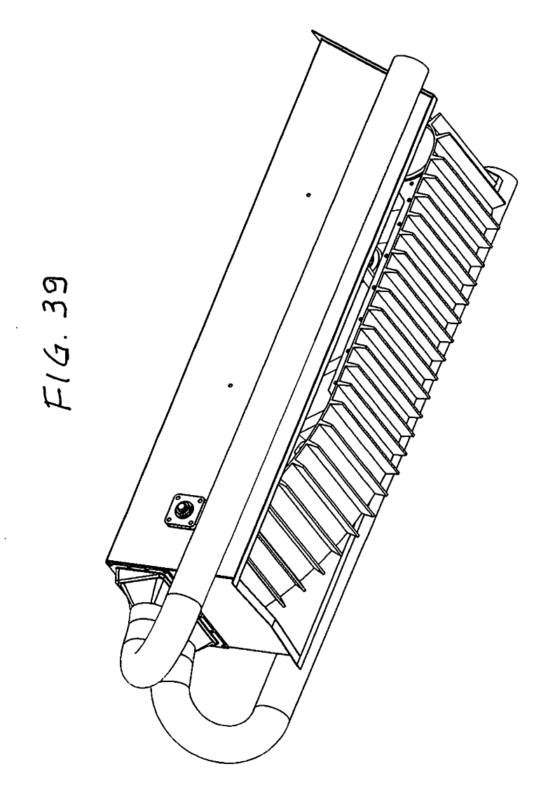

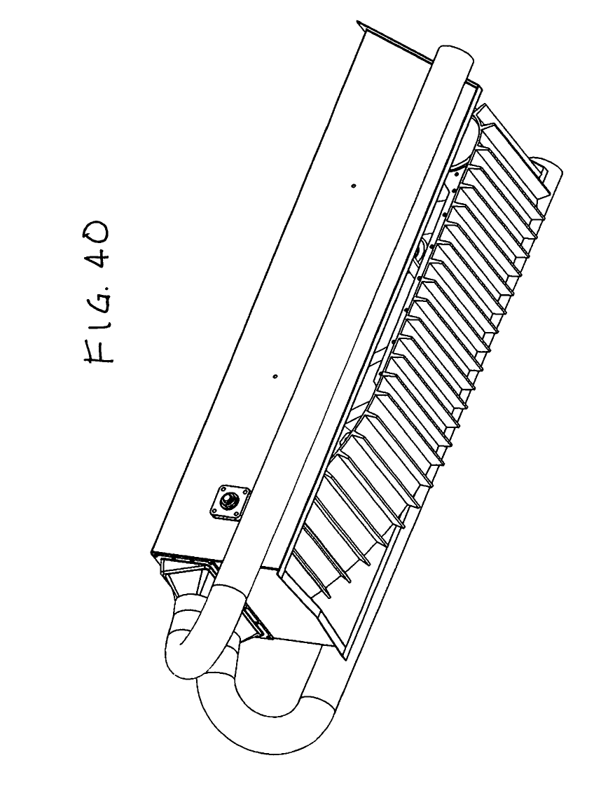

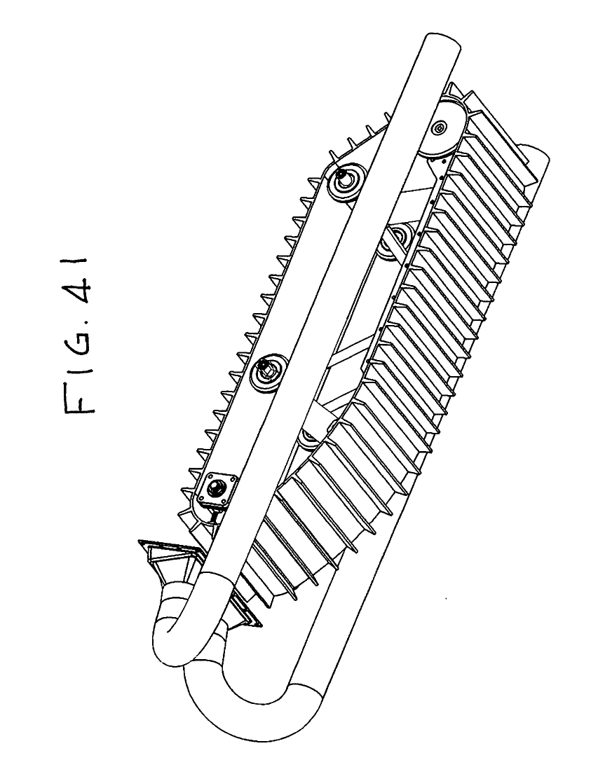

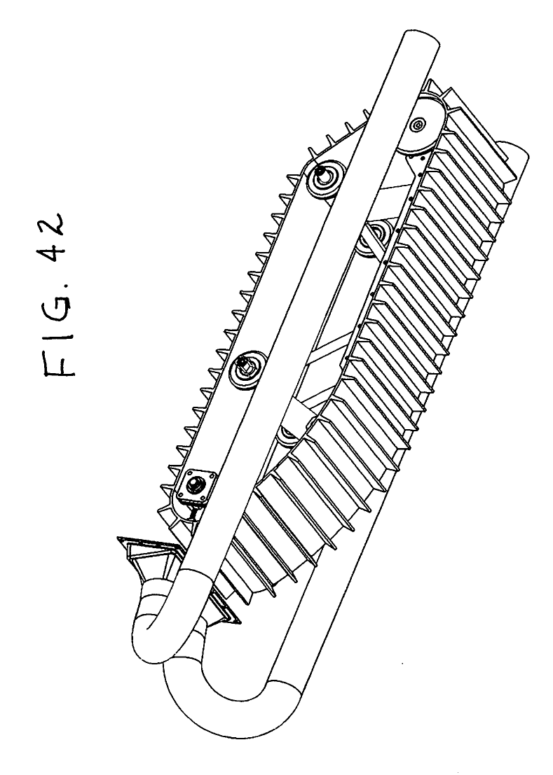

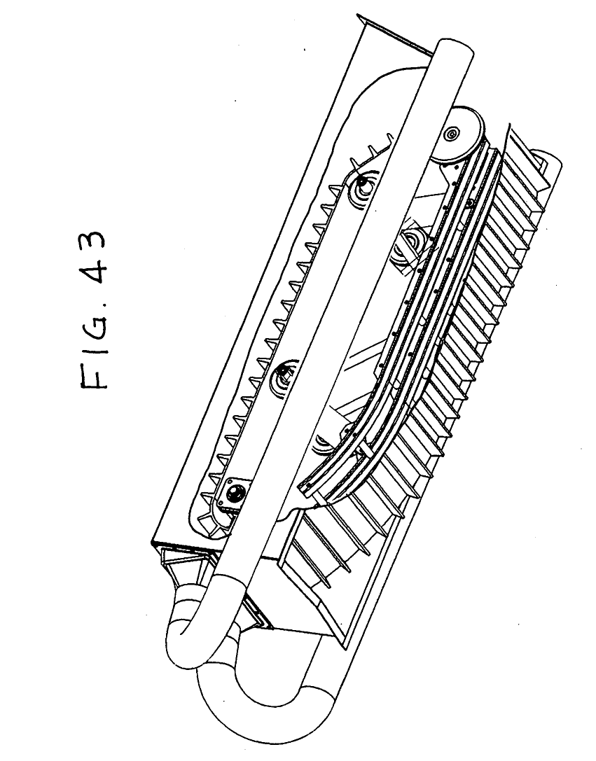

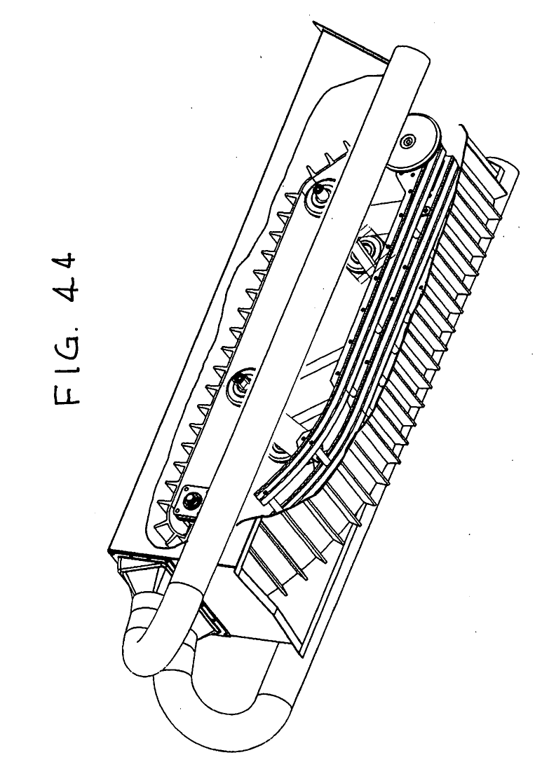

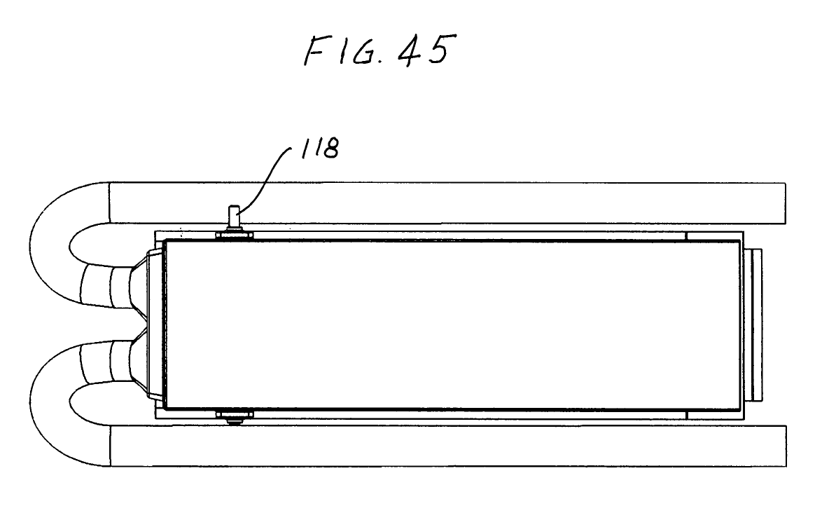

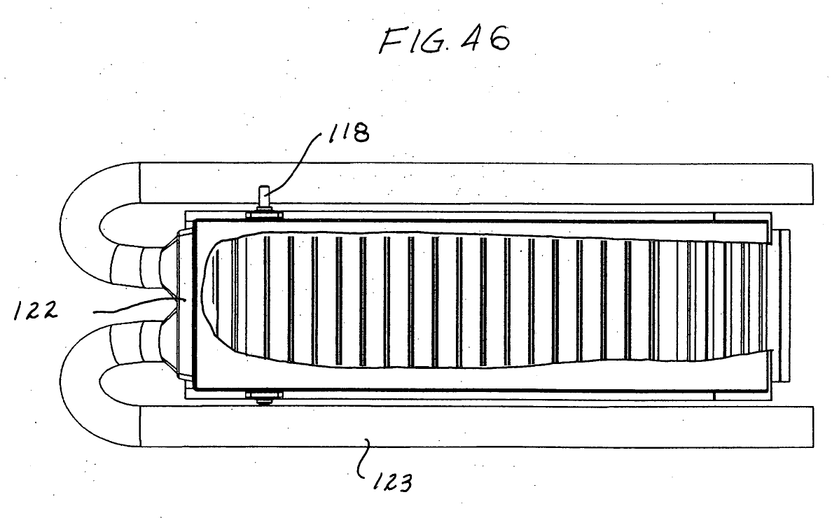

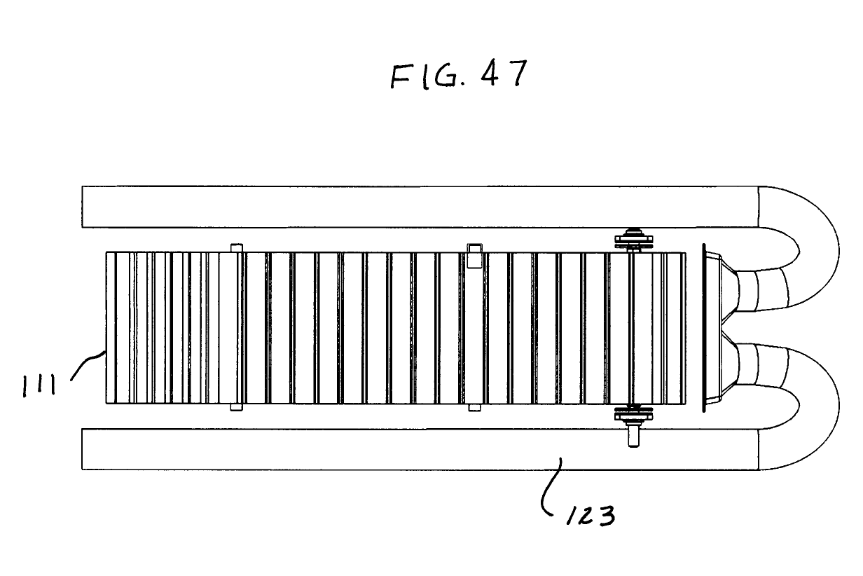

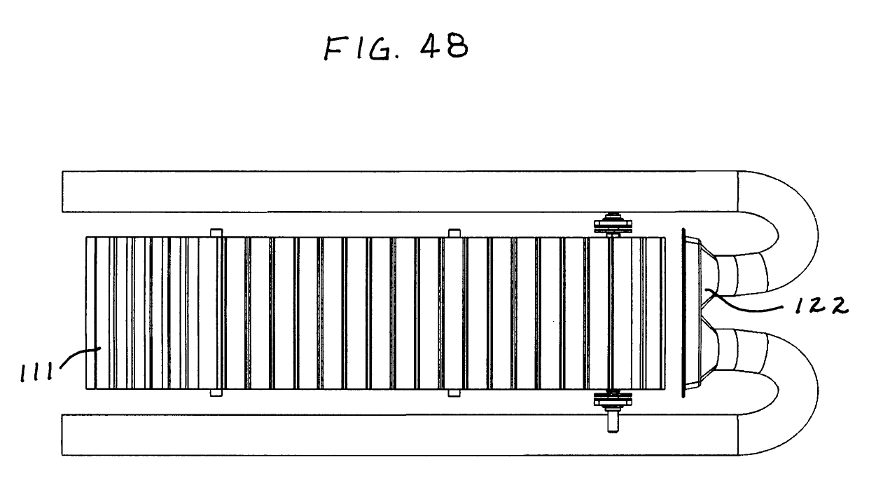

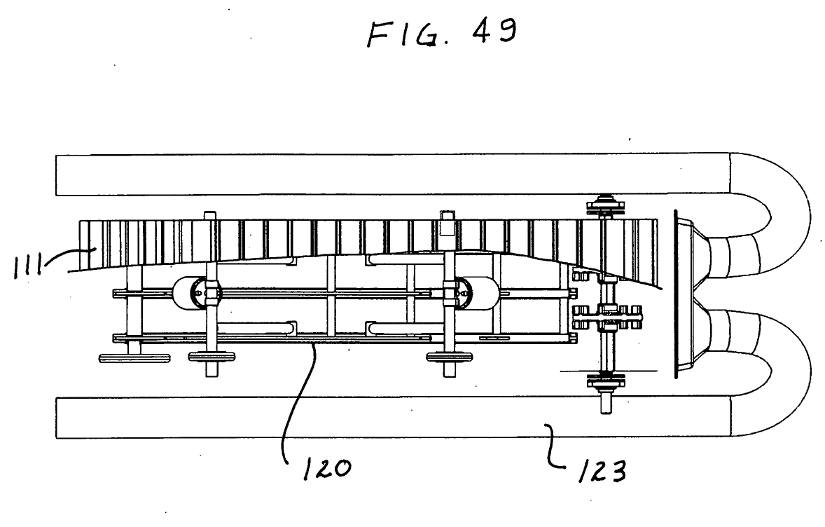

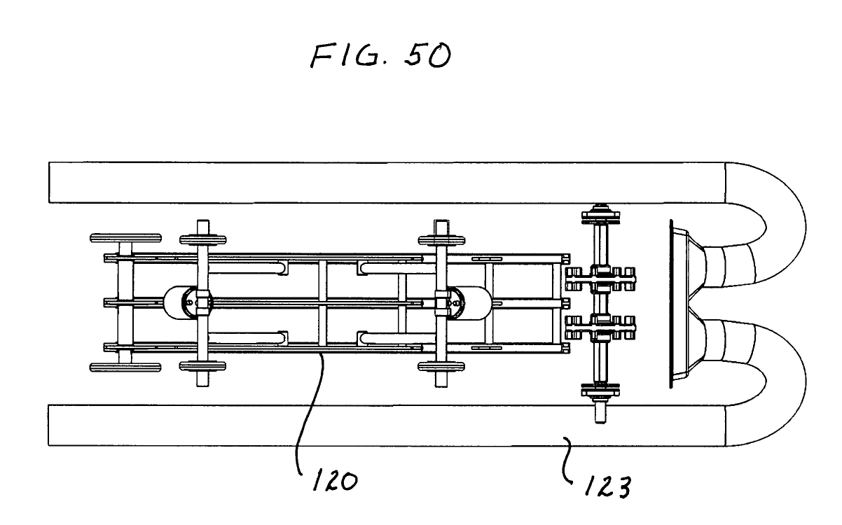

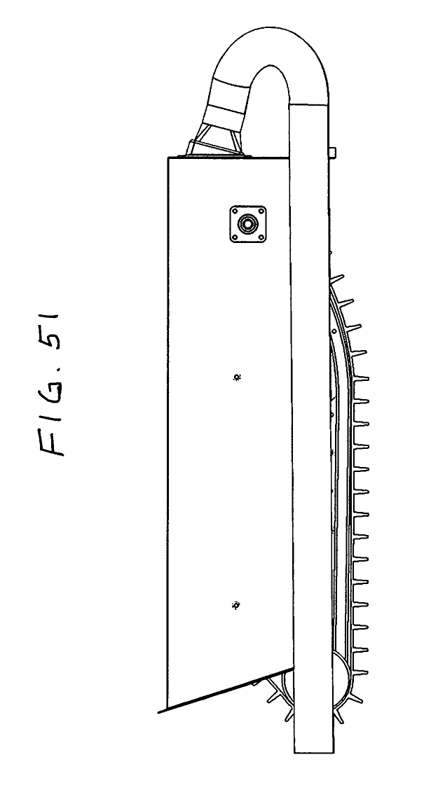

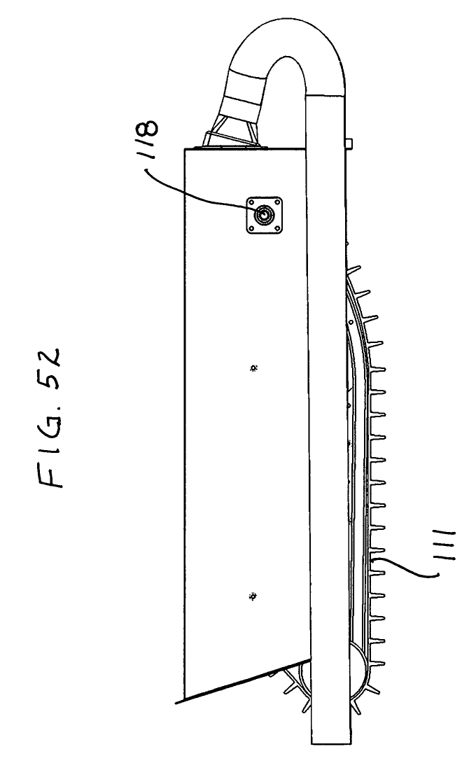

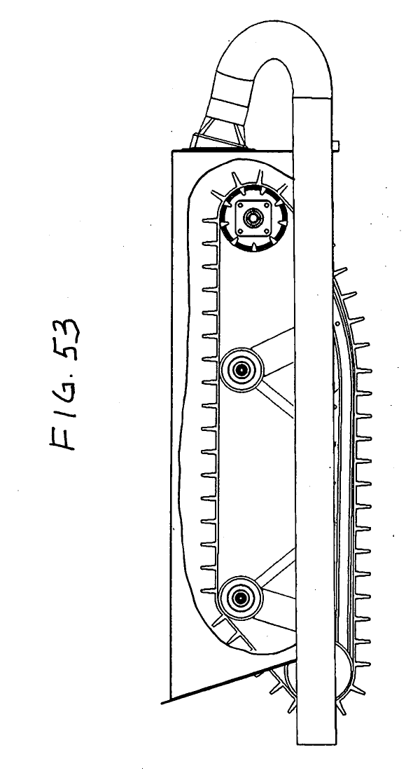

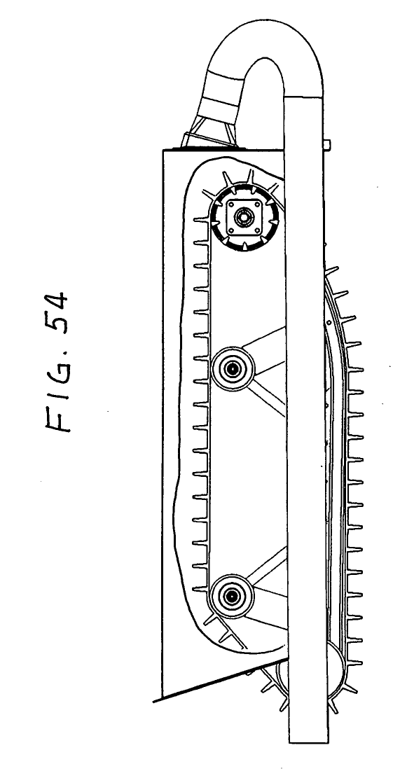

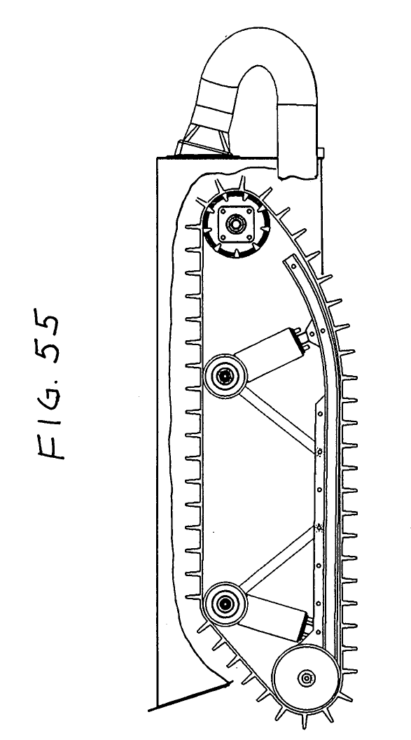

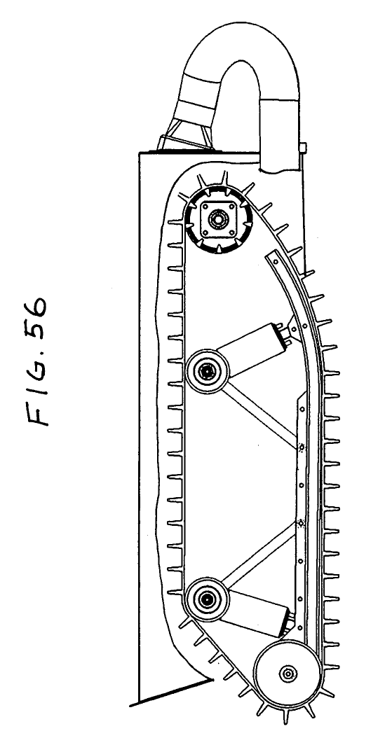

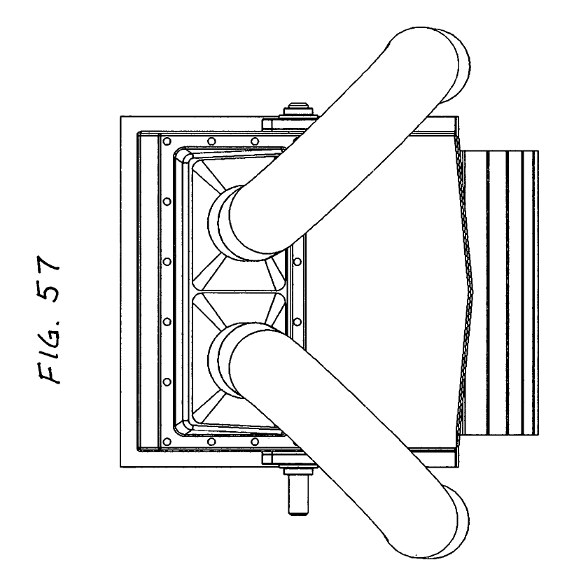

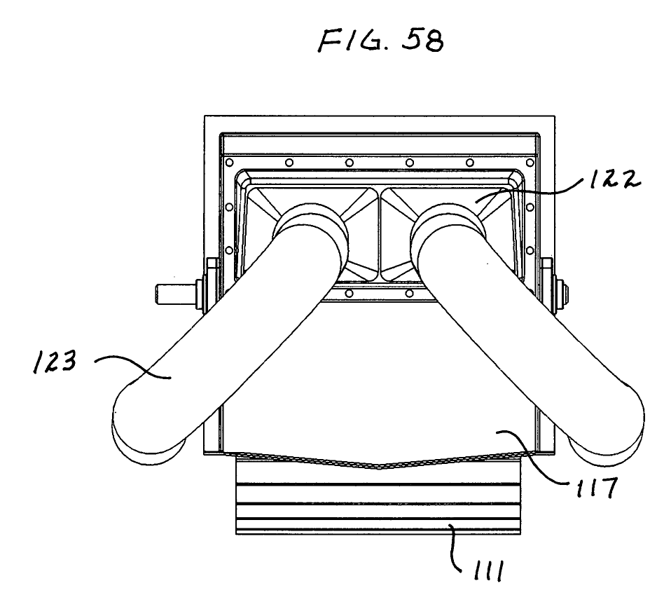

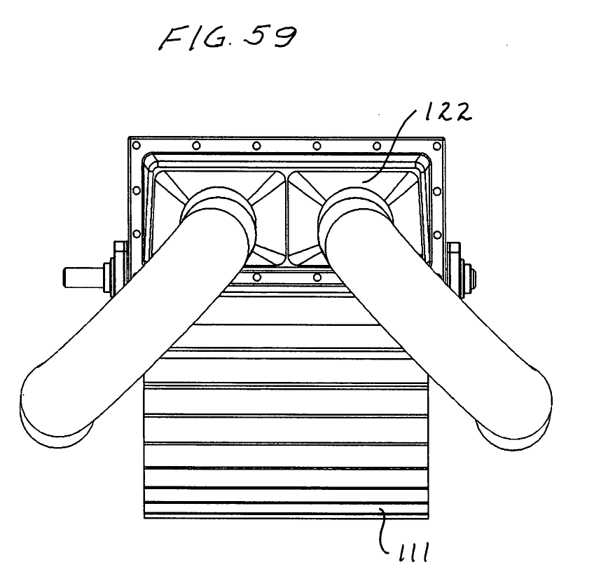

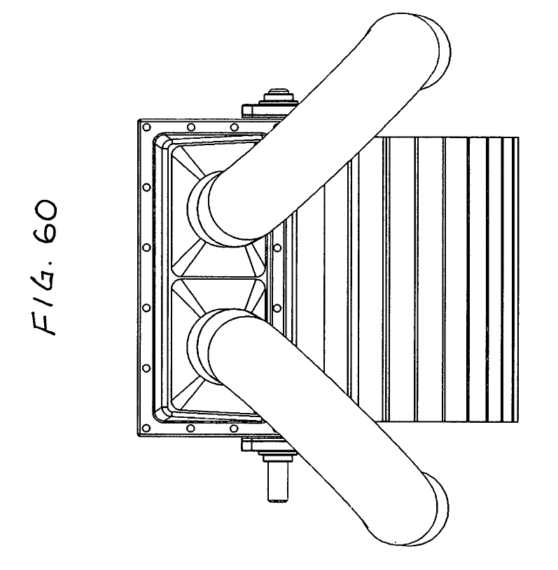

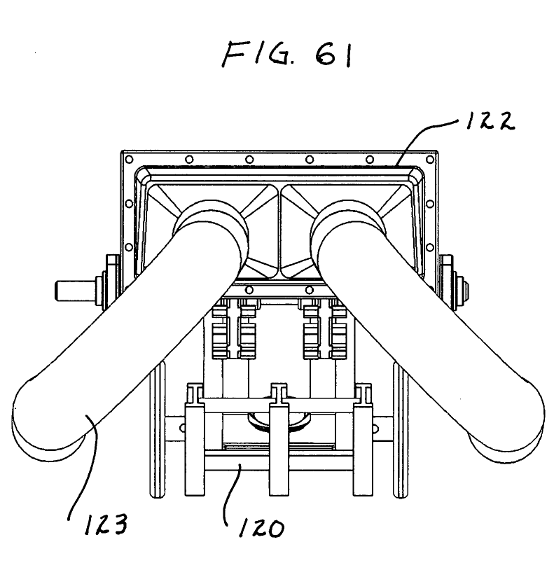

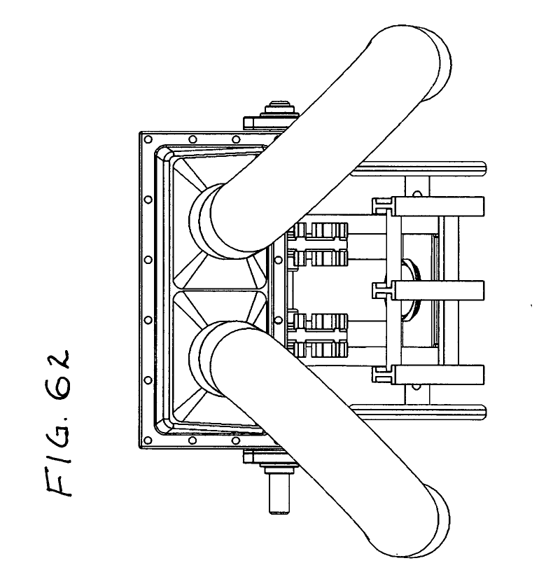

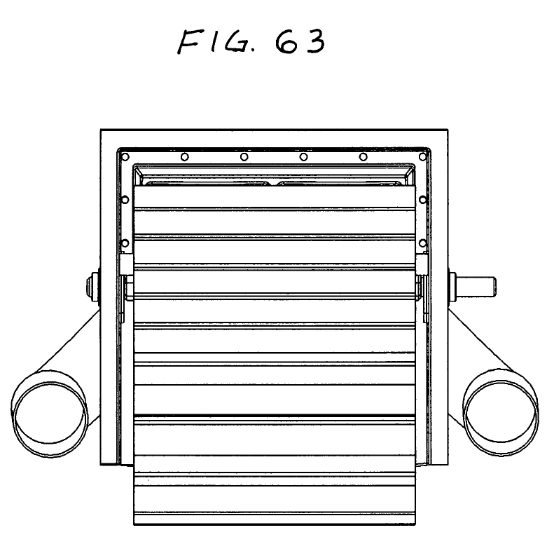

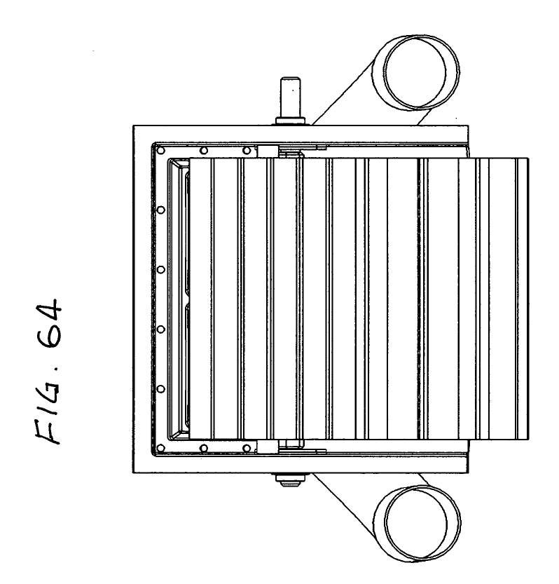

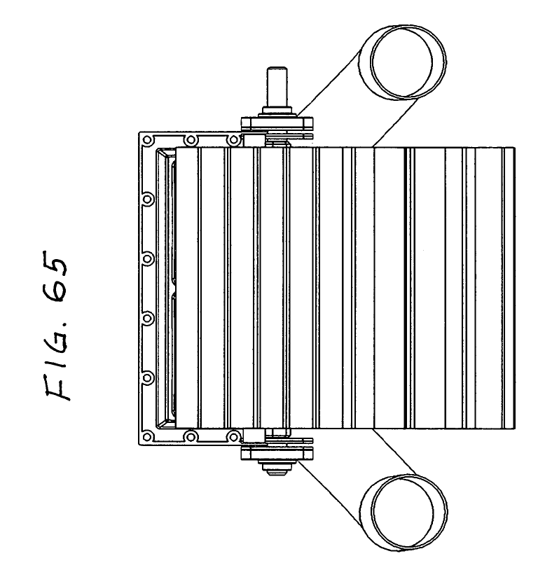

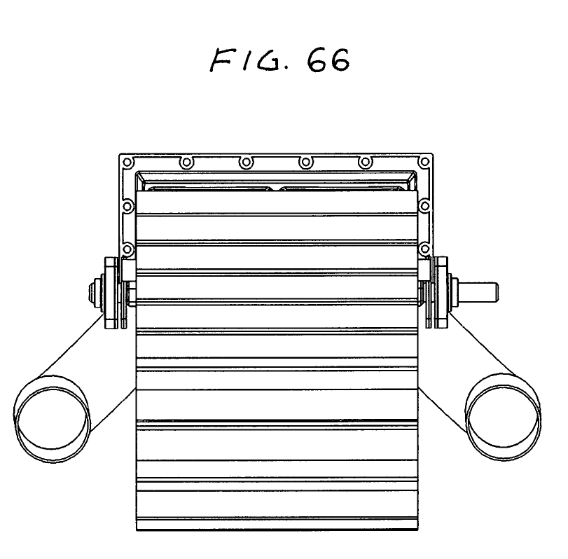

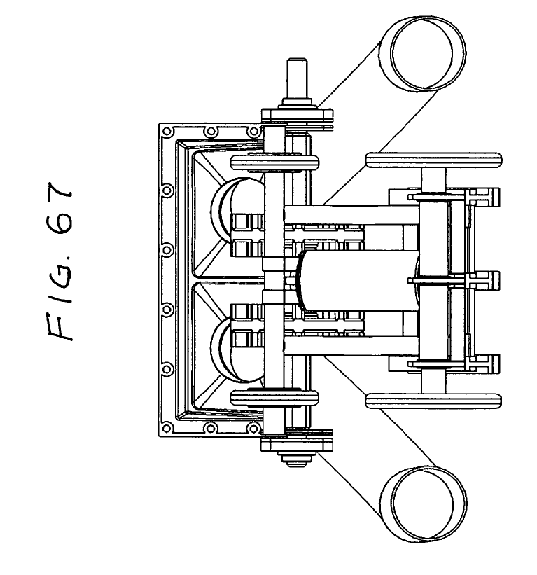

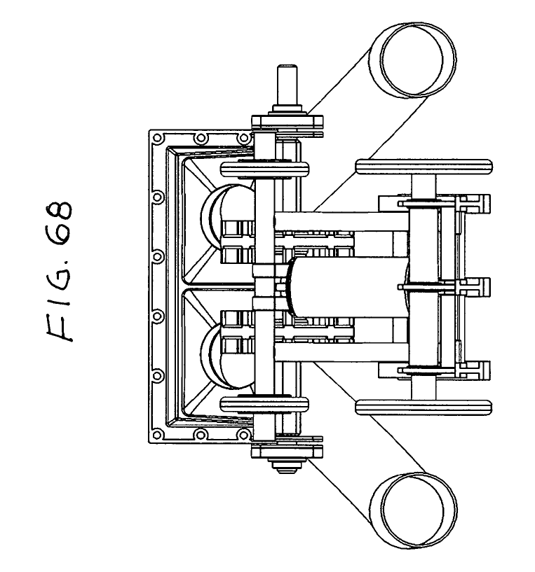

### DETAILED DESCRIPTION

Underwater, a paddle wheel works in complete opposition to itself remaining in nearly a stationary position, moving neither forward or back. By taking the water pulled over the top of the track and redirecting it back toward the rear of the vehicle through water jet exhaust tubes, thrust, in addition to that of the track, is created, The passive jet drive can be enhanced by including powered impellers or propellers in the water jet exhaust tubes. This change turns the passive jet drive propulsion system into a full powered propulsion system that dramatically increases water thrust out the back of the vehicle. The result will be extremely fast shallow draft water craft as well as submarines in all shapes and sizes capable of moving with ease above or below the surface of the water with the added advantage of being able to traverse over land when needed.

What is claimed is:

1. A water propulsion system comprising:
a closed-loop track having a top water engaging surface, a bottom water engaging surface, a first end and a second end,
a suspension frame supporting said track,
a drive mechanism coupled to said track and responsive to a power source for driving said track, and
a manifold including a water collection chamber positioned about the first end of said track for collecting water from said top water engaging surface and an exhaust tube coupled to the water collection chamber and extending from the first end towards the second of said track, whereby water collected from the top surface of the track in the water collection chamber at the first end of the track is directed through the exhaust tube and toward the second end of the track.

2. The water propulsion system of claim 1 further comprising a power driven propeller positioned in the exhaust tube for propelling water out of the exhaust tube toward the second end of the track.

3. The water propulsion system of claim 1 wherein said manifold further comprises another exhaust tube coupled to the water collection chamber and extending from the first end towards the second end of said track, the first exhaust tube being positioned to propel water therefrom to a first side of said track, the second exhaust tube being positioned to propel water therefrom to a second side of said track opposite said first side.

4. The water propulsion system of claim 3 further comprising a first power driven propeller positioned in said first exhaust tube and a second power driven propeller positioned in said second exhaust tube for propelling water out of the exhaust tubes toward the second end of the track.

5. The water propulsion system of claim I wherein said track includes a plurality of paddles extending obliquely from the outer surface of the track.
